(19) United States
(12) Patent Application Publication
(10) Pub. No.: US 2026/0336530 A1
(43) Pub. Date: Oct. 29, 2026

(54) CONTROL SYSTEM AND VEHICLE CONTROL SYSTEM

(71) Applicant: AUO Corporation, Hsinchu City (TW)

(72) Inventors: Yu-Chi Chen, Hsinchu City (TW); Chi-Yu Liu, Hsinchu City (TW)

(73) Assignee: AUO Corporation, Hsinchu City (TW)

(21) Appl. No.: 19/403,246

(22) Filed: Nov. 28, 2025

(30) Foreign Application Priority Data
Apr. 25, 2025 (TW) 114115752

(51) Int. Cl. B60R 11/02; B60K 35/22

(52) U.S. Cl. CPC B60R 11/0235; B60K 35/22; B60K 2360/1438; B60K 2360/146; B60K 2360/148; B60K 2360/21; B60K 2360/688

(57) ABSTRACT

A control system including a processing unit and a control device is provided. The control device is connected to the processing unit and includes multiple display units and an array-type uplifting mechanism. The array-type uplifting mechanism includes multiple columns. The columns are adapted to be independently raised and lowered. The display units are respectively disposed on the columns, and each of the display units is adapted to display a first graphical interface. A vehicle control system is also provided.

### CROSS-REFERENCE TO RELATED APPLICATION

This application claims the priority benefit of Taiwan application serial no. 114115752, filed on Apr. 25, 2025. The entirety of the above-mentioned patent application is hereby incorporated by reference herein and made a part of this specification.

### BACKGROUND

### Technical Field

The disclosure relates to a control system and a vehicle control system.

### Description of Related Art

Traditional electronic devices are mostly operated by buttons and knobs. However, each of the buttons and the knobs can only correspond to a single function and is not ergonomically designed.

### SUMMARY

The disclosure provides a control system and a vehicle control system that can meet various requirements. A user can sense a triggered button without looking at a screen, thereby improving driving safety and providing high operational comfort.

An embodiment of the disclosure provides a control system, which includes a processing unit and a control device. The control device is connected to the processing unit and includes multiple display units and an array-type uplifting mechanism. The array-type uplifting mechanism includes multiple columns. The columns are adapted to be independently raised and lowered. The display units are respectively disposed on the columns, and each of the display units is adapted to display a first graphical interface.

An embodiment of the disclosure provides a vehicle control system, which includes the control system. The control device is disposed in a vehicle.

Based on the above, the control system and the vehicle control system provided by the embodiments of the disclosure provide multiple graphical interfaces using multiple display units, and the graphical interface of each display unit is changeable. Accordingly, the control system and the vehicle control system may be configured to meet various requirements. In addition, the array-type uplifting mechanism enables the display units to adapt to a gesture of the user, thereby providing high operational comfort.

In order for the features and advantages of the disclosure to be more comprehensible, the following specific embodiments are described in detail in conjunction with the drawings.

### BRIEF DESCRIPTION OF THE DRAWINGS

FIG. 1A is a block diagram of a control system according to an embodiment of the disclosure, and FIG. 1B is a schematic diagram of a control device according to an embodiment of the disclosure.

FIG. 2 is a partial schematic diagram of a control system according to some embodiments of the disclosure.

FIG. 3 is a block diagram of a control system according to an embodiment of the disclosure.

FIG. 4A is a block diagram of a control system according to an embodiment of the disclosure, and FIG. 4B is a schematic diagram of a front display in FIG. 4A.

FIG. 5A is a partial top view of a control device according to an embodiment of the disclosure, and FIG. 5B is a partial top view of a control device according to an embodiment of the disclosure.

### DESCRIPTION OF THE EMBODIMENTS

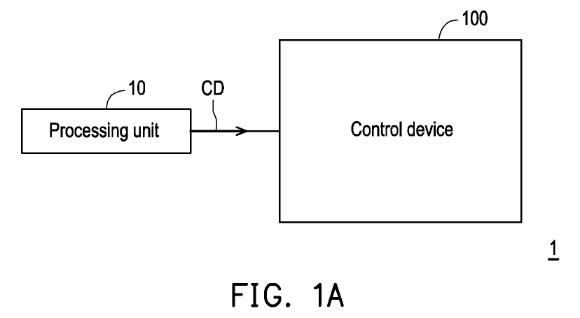

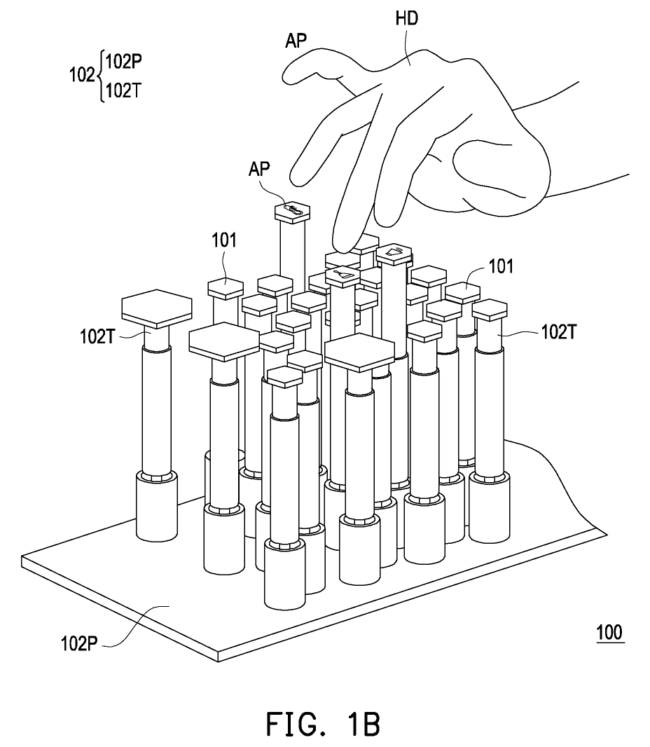

Please refer to FIGS. 1A and 1B, wherein FIG. 1A is a block diagram of a control system 1 according to an embodiment of the disclosure, and FIG. 1B is a schematic diagram of a control device 100 according to an embodiment of the disclosure.

In the embodiment, the control system 1 includes a processing unit 10 and a control device 100.

The processing unit 10 may be, for example, a central processing unit (CPU), a microprocessor, a digital signal processor (DSP), a programmable controller, a programmable logic device (PLD), other similar devices, or a combination of the devices, and the disclosure is not limited thereto.

The control device 100 is connected to the processing unit 10 and includes multiple display units 101 and an array-type uplifting mechanism 102. The array-type uplifting mechanism 102 includes a substrate 102P and multiple columns 102T. The columns 102T are adapted to be independently raised and lowered, and the display units 101 are respectively disposed on the columns 102T. Each display unit 101 may be, for example, a liquid crystal display or a light emitting diode display and is adapted to display a graphical interface AP. Each graphical interface AP is configured to be pressed and selected by a finger.

In some embodiments, the control system 1 may be implemented as a vehicle control system and be disposed at any position in a vehicle, such as between the driver seat and the front passenger seat, on the steering wheel, and on the vehicle door. By selecting any graphical interface AP, the user may control the temperature, the air volume, the audio volume, etc. in the vehicle through the processing unit 10.

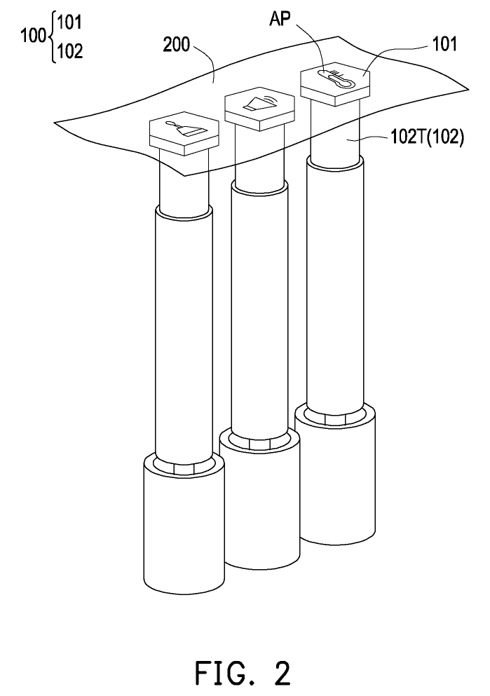

In some embodiments, as shown in FIG. 2, a protective layer 200 may be disposed on the control device 100 to cover a display surface of each display unit 101. The protective layer 200 may be, for example, the interior of the vehicle and is provided with a decorative pattern. The decorative pattern may be, for example, wood grain, but not limited thereto. In some embodiments not shown, only some of the display units 101 may be covered by the protective layer 200, and the other display units 101 are not covered by the protective layer 200.

It should be noted that the disclosure is not limited to the aforementioned vehicle control system. In other embodiments, the control system 1 may be implemented in other environments other than the vehicle.

It should also be noted that although one display unit 101 is disposed on each column 102T in FIG. 1B, the disclosure is not limited thereto. In some embodiments, one or more display units 101 are disposed on one column 102T. In some embodiments, a single display unit 101 may be raised by multiple columns 102T, and the uplifting heights of the columns 102T corresponding to the display unit 101 may be the same or different, so as to allow the display unit 101 to be horizontally configured relative to the substrate 102P or tilted relative to the substrate 102P.

It should be noted that each column 102T in FIG. 1B may have multiple uplifting heights. In other words, each column 102T is provided with multiple uplifting modes. In different uplifting modes, the uplifting heights of the column 102T are different. The uplifting mode of each column 102T may be determined by control information CD provided by the processing unit 10. Accordingly, the display units 101 on the array-type uplifting mechanism 102 may be adapted to gestures of the user, thereby improving the comfort of the user when using the control device 100.

In some embodiments, each display unit 101 includes at least one touch electrode. The user may lift the columns 102T below by touching some of the display units 101. Specifically, when a hand of the user touches some of the display units 101, the touch electrodes of the display units 101 generate touch information due to the touch. The processing unit 10 connected to the control device 100 generates the corresponding control information CD according to the touch information to control the uplifting heights of the columns 102T, so that the array-type uplifting mechanism 102 presents a state (for example, the state shown in FIG. 1B) corresponding to the gesture of the user.

Furthermore, the graphical interface AP displayed by each display unit 101 is changeable. Specifically, when the user presents different gestures, the graphical interfaces AP displayed on the display units 101 corresponding to fingers of the user also correspondingly change. For example, when the user presents a gesture, the graphical interfaces AP on the display units 101 are adapted to control an air conditioning system in the vehicle; and when the user presents another gesture, the graphical interfaces AP on the display units 101 are adapted to control an audio system in the vehicle. The same display unit 101 may display different graphical interfaces AP under different requirements.

In some embodiments, the array-type uplifting mechanism 102 of the control device 100 further includes at least one stress sensor (not shown) configured to sense stress generated when the columns 102T are pressed by the user. The stress sensor generates corresponding stress information. The processing unit 10 connected to the control device 100 generates the corresponding control information CD according to the stress information to control the uplifting heights of the columns 102T, so that the array-type uplifting mechanism 102 presents the state (for example, the state shown in FIG. 1B) corresponding to the gesture of the user. Furthermore, when the user presents different gestures, the graphical interfaces AP displayed on the display units 101 corresponding to the fingers of the user also correspondingly change. For example, when the user presents a gesture, the graphical interfaces AP on the display units 101 are adapted to control the air conditioning system in the vehicle; and when the user presents another gesture, the graphical interfaces AP on the display units 101 are adapted to control the audio system in the vehicle.

In some embodiments, the array-type uplifting mechanism 102 includes at least one stress sensor configured to sense whether the columns 102T are pressed by the user; and each display unit 101 includes at least one touch electrode configured to sense whether the display units 101 are touched by the user. The stress sensor generates the stress information, and the touch electrode generates the touch information. The processing unit 10 connected to the control device 100 generates the corresponding control information CD according to the stress information and the touch information to control the uplifting heights of the columns 102T and the graphical interfaces AP displayed on the display units 101.

In order to fully illustrate various implementation aspects of the disclosure, other embodiments of the disclosure will be described below. It must be noted here that the following embodiments continue to use the reference numerals and some content of the aforementioned embodiment, wherein the same numerals are adopted to represent the same or similar elements, and the description of the same technical content is omitted. Reference may be made to the aforementioned embodiment for the description of the omitted part, which will not be repeated in the following embodiments.

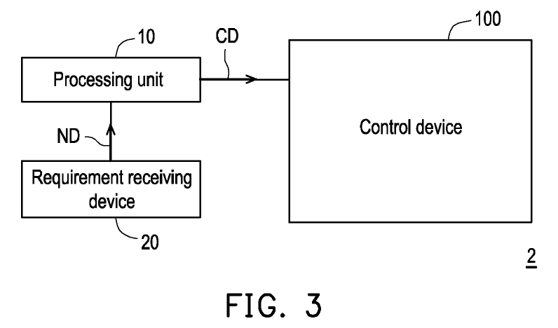

Please refer to FIGS. 1B and 3, wherein FIG. 3 is a block diagram of a control system 2 according to an embodiment of the disclosure.

The control system 2 includes a processing unit 10, a requirement receiving device 20 and a control device 100. The control device 100 of the control system 2 is provided with the same or similar structure (as shown in FIG. 1B) and functions as the control device 100 of the control system 1, which will not be described in detail herein.

The requirement receiving device 20 is connected to the processing unit 10. The processing unit 10 generates control information CD according to requirement information ND provided by the requirement receiving device 20, and determines the uplifting height of each column 102T of the control device 100 and/or the graphical interface AP displayed on each display unit 101 with the control information CD.

In an embodiment, the requirement receiving device 20 is a camera, the requirement information ND is image information, and the processing unit 10 includes a motion detection algorithm. The processing unit 10 generates the control information CD using the motion detection algorithm and the image information generated by the camera. Specifically, the camera may be used to film the user, and the corresponding control information CD may be generated according to the motion of the user. For example, in an embodiment, the control system 2 may be implemented as the vehicle control system. The requirement receiving device 20 is the camera configured to film a person in the vehicle. When a hand HD of the driver reaches toward the control device 100, the camera instantly generates the image information corresponding to an image of the driver. The motion detection algorithm of the processing unit 10 analyzes the image information, so that the processing unit 10 may generate the corresponding control information CD to determine the uplifting height of each column 102T of the control device 100, so that the array-type uplifting mechanism 102 presents the state (for example, the state shown in FIG. 1B) corresponding to the gesture of the driver. Furthermore, when the driver presents different gestures, the state presented by the array-type uplifting mechanism 102 also correspondingly changes. Furthermore, when the driver presents different gestures, the graphical interfaces AP displayed on the display units 101 corresponding to the fingers of the driver also correspondingly change. For example, when the driver presents a gesture, the graphical interfaces AP on the display units 101 are adapted to control the air conditioning system in the vehicle; and when the driver presents another gesture, the graphical interfaces AP on the display units 101 are adapted to control the audio system in the vehicle.

In an embodiment, the requirement receiving device 20 is a microphone, the requirement information ND is voice information, and the processing unit 10 includes a voice control algorithm. The processing unit 10 generates the control information CD using the voice control algorithm and the voice information generated by the microphone. Specifically, the user may use the microphone to voice-control the control system 2, so that the processing unit 10 generates the corresponding control information CD. For example, in an embodiment, the control system 2 may be implemented as the vehicle control system, and the requirement receiving device 20 may be the microphone. When the driver proposes a control requirement through the microphone, the microphone instantly generates the voice information corresponding to the control requirement of the driver. The voice control algorithm of the processing unit 10 analyzes the voice information, so that the processing unit 10 may generate the corresponding control information CD to determine the uplifting height of each column 102T of the control device 100, so that the array-type uplifting mechanism 102 presents the state (for example, the state shown in FIG. 1B) corresponding to the control requirement of the driver. Furthermore, when the driver proposes different control requirements, the state presented by the array-type uplifting mechanism 102 also correspondingly changes. Furthermore, when the driver proposes different control requirements, the graphical interfaces AP displayed on the display units 101 also correspondingly change. For example, when the driver proposes a first control requirement, the graphical interfaces AP on the display units 101 are adapted to control the air conditioning system in the vehicle; and when the driver proposes a second control requirement, the graphical interfaces AP on the display units 101 are adapted to control the audio system in the vehicle.

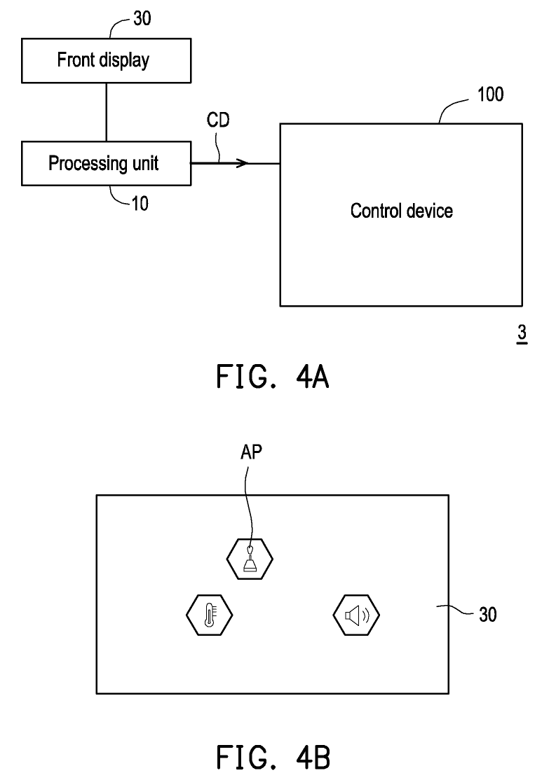

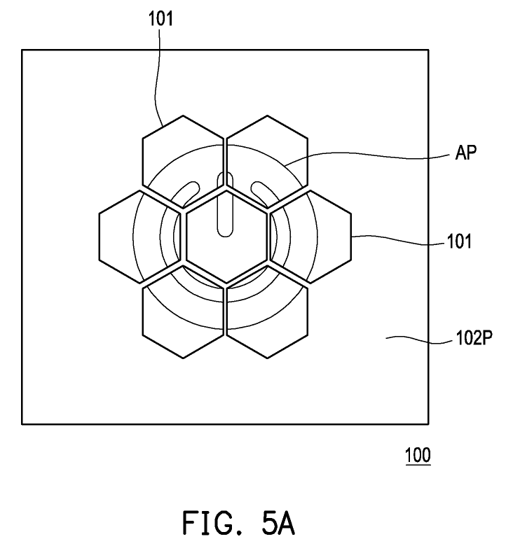

Please refer to FIGS. 1B, 4A, and 4B, wherein FIG. 4A is a block diagram of a control system 3 according to an embodiment of the disclosure, and FIG. 4B is a schematic diagram of a front display 30 in FIG. 4A.

In the embodiment, the control system 3 includes a processing unit 10, the front display 30, and a control device 100. The control device 100 of the control system 3 has the same or similar structure (as shown in FIG. 1B) and functions as the control device 100 of the control system 1, which will not be described in detail herein.

The control device 100 and the front display 30 are connected to the processing unit 10. The front display 30 displays multiple graphical interfaces AP displayed on multiple activated display units 101 in the array-type uplifting mechanism 102. Accordingly, the driver does not need to lower his head to view the graphical interfaces AP on the array-type uplifting mechanism 102, but only needs to select a required function by the array-type uplifting mechanism 102 according to the graphical interface AP displayed on the front display 30, thereby improving driving safety.

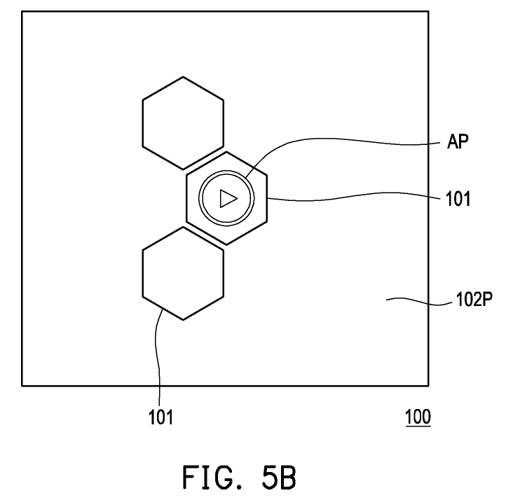

Please refer to FIGS. 1B, 5A, and 5B, wherein FIG. 5A is a partial top view of the control device shown in FIGS. 1B, and 5B is a partial top view of the control device shown in FIG. 1B.

In the embodiment shown in FIGS. 5A and 5B, the graphical interfaces AP of the display units 101 are configured to provide the same function (for example, a power switch function shown in FIG. 5A or a playback function shown in FIG. 5B). Since the columns 102T below the display units 101 may be independently raised and lowered, it should be understood that the display surfaces of the display units 101 may be coplanar or non-coplanar.

In summary, the control system and the vehicle control system provided by the embodiments of the disclosure provide multiple graphical interfaces using multiple display units, and the graphical interface of each display unit is changeable. Accordingly, the control system and the vehicle control system may be configured to meet various requirements. In addition, the array-type uplifting mechanism enables the display units to adapt to the gesture of the user, thereby providing high operational comfort.

What is claimed is:

1. A control system, comprising:
a processing unit; and
a control device, connected to the processing unit and comprising a plurality of display units and an array-type uplifting mechanism, wherein the array-type uplifting mechanism comprises a plurality of columns, the columns are adapted to be independently raised and lowered, the display units are respectively disposed on the columns, and each of the display units is adapted to display a first graphical interface.

2. The control system according to claim 1, further comprising a protective layer disposed on a display surface of at least one of the display units, wherein the protective layer has a decorative pattern.

3. The control system according to claim 1, wherein each of the columns is provided with a plurality of uplifting modes, and uplifting heights of the columns are different in the different uplifting modes.

4. The control system according to claim 3, wherein the display units are adapted to a gesture of a user.

5. The control system according to claim 1, further comprising a requirement receiving device connected to the processing unit, wherein the processing unit generates control information according to requirement information provided by the requirement receiving device, and controls uplifting heights of the columns according to the control information.

6. The control system according to claim 5, wherein the requirement receiving device is a camera, the requirement information is image information, the processing unit comprises a motion detection algorithm, and the processing unit generates the control information using the motion detection algorithm and the image information generated by the camera.

7. The control system according to claim 5, wherein the requirement receiving device is a microphone, the requirement information is voice information, the processing unit comprises a voice control algorithm, and the processing unit generates the control information using the voice control algorithm and the voice information generated by the microphone.

8. The control system according to claim 5, wherein the processing unit controls the first graphical interface displayed on each of the display units according to the control information.

9. The control system according to claim 1, wherein each of the display units comprises at least one touch electrode, and the processing unit generates control information according to touch information generated by the at least one touch electrode, and controls uplifting heights of the columns according to the control information.

10. The control system according to claim 9, wherein the processing unit controls the first graphical interface displayed on each of the display units according to the control information.

11. The control system according to claim 1, wherein the array-type uplifting mechanism further comprises at least one stress sensor, and the processing unit generates control information according to stress information generated by the at least one stress sensor, and controls uplifting heights of the columns according to the control information.

12. The control system according to claim 11, wherein the processing unit controls the first graphical interface displayed on each of the display units according to the control information.

13. The control system according to claim 1, further comprising a front display connected to the processing unit, wherein the front display is adapted to display a second graphical interface corresponding to the first graphical interface.

14. The control system according to claim 1, wherein a plurality of the first graphical interfaces of the display units are configured to provide a same function.

15. A vehicle control system, comprising:
a processing unit; and
a control device, connected to the processing unit and comprising a plurality of display units and an array-type uplifting mechanism, wherein the array-type uplifting mechanism comprises a plurality of columns, the columns are adapted to be independently raised and lowered, the display units are respectively disposed on the columns, and each of the display units is adapted to display a graphical interface,
wherein the control device is disposed in a vehicle.
